(19) United States
(12) Patent Application Publication
(10) Pub. No.: US 2024/0035461 A1
(43) Pub. Date: Feb. 1, 2024

(54) INFLATION PUMP AND INFLATION DEVICE

(71) Applicant: GUANGDONG BOLTPOWER ENERGY CO., LTD., Dongguan City (CN)

(72) Inventor: Yuefei LIAO, Dongguan City (CN)

(21) Appl. No.: 18/357,281

(22) Filed: Jul. 24, 2023

(30) Foreign Application Priority Data
Jul. 29, 2022 (CN) 2022219960563
Aug. 26, 2022 (CN) 2022222702726

(51) Int. Cl. F04B 37/12; F04B 49/12; F04B 35/04; H02H 7/08

(52) U.S. Cl. CPC F04B 37/12; F04B 49/125; F04B 35/04; H02H 7/08; F04B 53/08

(57) ABSTRACT

The present disclosure provides an inflation pump and inflation device. The inflation pump includes a drive assembly, an inflating assembly, and a detection assembly. One end of the drive assembly is connected to the inflating assembly to provide power for the inflating assembly; one end of the inflating assembly away from the drive assembly is used to connect to a to-be-inflated device, and one side of the inflating assembly near the to-be-inflated device is provided with a detection port; and the detection assembly is connected to the detection port for detecting the air pressure information of the to-be-inflated device.

### CROSS-REFERENCE TO RELATED APPLICATION

The present disclosure claims priority of Chinese patent application with the filing number 2022222702726 filed on Aug. 26, 2022 with the Chinese Patent Office, and Chinese patent application with the filing number 2022219960563 filed on Jul. 29, 2022 with the Chinese Patent Office, the entire contents of both of which are incorporated herein by reference for all purposes.

### TECHNICAL FIELD

The present disclosure relates to the technical field of inflation pumps, in particular to an inflation pump.

### BACKGROUND ART

Inflation pumps, also called as air compressors, are mainly used to inflate tires, basketballs, soccer balls, and other objects based on the principle of atmospheric pressure.

At present, when the traditional inflation pump inflates the object, it is able to determine whether the inflation amount is appropriate only by means of manually pressing on the object. However, this approach is dependent on subjective perception of user, thereby resulting in lower accuracy.

### SUMMARY

In view of this, an object of embodiments of the present disclosure is to provide an inflation pump, so as to solve the problem that the current inflation pumps are unable to accurately assess the appropriateness of the inflation volume when inflating the to-be-inflated device.

In the first aspect, an embodiment of the present disclosure provides an inflation pump, and the inflation pump comprises a drive assembly, an inflating assembly, and a detection assembly, wherein one end of the drive assembly is connected to the inflating assembly to provide power for the inflating assembly; one end of the inflating assembly away from the drive assembly is configured to be connected to a to-be-inflated device, and one side of the inflating assembly close to the to-be-inflated device is provided with a detection port; and the detection assembly is connected to the detection port for detecting the air pressure information of the to-be-inflated device.

In the embodiment of the present disclosure, when the to-be-inflated device is connected to the inflating assembly, the air pressure information is the same for both. Therefore, by connecting the detection assembly to the detection port on the inflating assembly, the detection assembly can obtain the air pressure information of the to-be-inflated device, such that when the drive assembly drives the inflating assembly to inflate the to-be-inflated device, it is possible to evaluate whether the inflation amount for the to-be-inflated device is appropriate based on the air pressure information of the to-be-inflated device.

In the embodiment, the inflating assembly comprises a transmission assembly and a cylinder assembly, wherein one end of the transmission assembly is connected to the drive assembly and the other end away from the drive assembly is connected to the cylinder assembly for transmitting power to the cylinder assembly; and one side of the cylinder assembly close to the to-be-inflated device is provided with the detection port.

In the embodiment, the transmission assembly comprises a connecting rod, a transmission wheel, a housing, an eccentric wheel arranged on the housing, and a piston arranged on the connecting rod, wherein one end of the piston away from the connecting rod is connected to the cylinder assembly and one end of the connecting rod away from the piston is connected to the eccentric wheel; the transmission wheel is connected to the eccentric wheel and the drive assembly, respectively, for transmitting power to the eccentric wheel; and one end of the housing is connected to the drive assembly and the other end, away from the drive assembly, is connected to the cylinder assembly.

In the embodiment of the present disclosure, by connecting the two ends of the housing to the drive assembly and the cylinder assembly, respectively, the eccentric wheel provided on the housing is limited, thereby avoiding the damage to the inflation pump caused by the movement of the eccentric wheel.

In the embodiment, the transmission assembly also comprises a housing cover, and the housing cover is connected to the housing.

In an embodiment of the present disclosure, a housing cover is connected to the housing, so that the eccentric wheel arranged on the housing is covered by the housing cover, the probability of foreign matter entering the eccentric wheel is reduced, and the protection for the eccentric wheel is enhanced.

In the embodiment, the cylinder assembly comprises an air nozzle and an air cylinder, wherein the air nozzle is provided with the detection port, and one end of the air nozzle is configured to be connected to the to-be-inflated device; and one end of the air cylinder is connected to one end of the air nozzle away from the to-be-inflated device, and one end of the air cylinder away from the air nozzle is connected to the transmission assembly.

In the embodiment, the air nozzle is connected to the transmission assembly; an accommodating space is formed at the connection position between the air nozzle and the transmission assembly; and the air cylinder is located in the accommodating space.

In the embodiment of the present disclosure, by arranging the air cylinder in the accommodating space formed at the connection position between the air nozzle and the transmission assembly, the space occupied by the components of the inflation pump is reduced and the volume of the inflation pump is reduced.

In the embodiment, the inflating assembly comprises the transmission assembly and the cylinder assembly, wherein one end of the cylinder assembly is connected to the drive assembly and a detection port is provided on one side of the cylinder assembly close to the to-be-inflated device; and the transmission assembly is provided on the cylinder assembly for transmitting the power to the cylinder assembly.

In the embodiment of the present disclosure, the cylinder assembly is fixedly connected to the transmission assembly by providing the transmission assembly on the cylinder assembly.

In the embodiment, the transmission assembly comprises a connecting rod, a transmission wheel, an eccentric wheel arranged on the cylinder assembly, and a piston arranged on the connecting rod, wherein one end of the connecting rod is connected to the cylinder assembly, and the other end away from the cylinder assembly is connected to the eccentric wheel; and the transmission wheel is respectively connected to the eccentric wheel and the drive assembly for transmitting the power.

In the embodiment, the cylinder assembly comprises an air nozzle, an air cylinder, and a housing, wherein the air nozzle is provided with the detection port; one end of the air nozzle is configured to be connected to the to-be-inflated device and the other end away from the to-be-inflated device is connected to the air cylinder; the transmission assembly is provided on the housing; the air cylinder is connected to the housing; and the housing is connected to the drive assembly.

In the embodiment, a bottom of the housing is provided with an opening; and a drive shaft of the drive assembly penetrates through the opening and is connected to the transmission assembly.

In the embodiment of the present disclosure, the bottom of the housing is provided with an opening; and a drive shaft of the drive assembly penetrates through the opening at the bottom of the housing and is connected to the transmission assembly, thereby reducing the length of the inflation pump in the direction of the drive shaft.

In the embodiment, the air nozzle, the air cylinder, and the housing are integrally molded.

In the embodiment of the present disclosure, by integrally molding the air nozzle, the air cylinder and the housing, the sealing and the overall stability of the connection between the inflation mechanism and the to-be-inflated device is improved.

In the embodiment, the inflation pump further comprises a heat dissipation assembly, which is arranged on a side of the drive assembly away from the transmission assembly, and configured to perform heat dissipation for the drive assembly.

In the embodiment of the present disclosure, by providing the heat dissipation assembly on the side of the drive assembly away from the transmission assembly, heat is dissipated from the drive assembly, so that the heat generated by the drive assembly during operation can be effectively dispersed, thereby improving the service life of the inflation pump.

In the embodiment, the detection assembly comprises an air pressure sensor assembly, which is in communication with the detection port.

In the second aspect, an embodiment of the present disclosure provides an inflation device, and the inflation device comprises an inflation pump as provided in the above embodiment in first aspect and/or any of the possible embodiments in combination with the above embodiment in first aspect; a main control board, electrically connected to the detection assembly of the inflation pump, for controlling the operating state of the inflation pump; a power supply, electrically connected to the main control board and the inflation pump, for supplying power to the main control board and the inflation pump; and a casing, wherein the inflation pump, the main control board, and the power supply are located in the casing.

In the embodiment, the inflation device further comprises a thermal insulating assembly, and the thermal insulating assembly is provided between the inflating assembly of the inflation pump and the to-be-inflated device.

In embodiments of the present disclosure, by providing the thermal insulating assembly between the inflating assembly and the casing, deformation of the casing due to the influence of high-temperature inflating assembly is avoided.

In the embodiment, the main control board comprises a microprocessor and a switch module, wherein the microprocessor is connected to the detection assembly for generating output signals based on the air pressure information of the to-be-inflated device and the preset value; and the switch module is connected to the microprocessor, for selectively connecting the power supply to the inflation pump based on the output signals.

In the embodiment, the microprocessor is configured to command the switch module to be activated so that the power supply is connected to the inflation pump, when the air pressure information of the to-be-inflated device is less than a preset value; or, to command the switch module to be deactivated so that the power supply is disconnected from the inflation pump, when the air pressure information of the to-be-inflated device is greater than or equal to a preset value.

In the third aspect, an embodiment of the present disclosure provides an inflation device, and the inflation device comprises the inflation pump, a power supply, at least one current output port, a first protection circuit, and a second protection circuit, wherein the power supply is electrically connected to at least one current output port for outputting a first current to external devices; the power supply is electrically connected to the inflation pump for outputting a second current to the inflation pump; the first protection circuit is coupled to the power supply for protecting the power supply; and the second protection circuit is coupled to the power supply for performing overcurrent protection for the inflation pump.

It is understood that the first protection circuit is coupled to the power supply to protect the power supply; and the second protection circuit is coupled to the power supply to protect the inflation pump from overcurrent. The first protection circuit and the second protection circuit cooperate with each other to jointly protect the inflation device. Therefore, the safety of the inflation device is improved.

In the embodiment, the inflation device further comprises a pair of output terminals; and the power supply is electrically connected to the output terminals for outputting a third current for starting the engine of the vehicle.

Details of one or more embodiments of the present disclosure are presented in the drawings and description below. Other features, objects, and advantages of the present disclosure will become apparent from the specification, the drawings, and the claims.

### BRIEF DESCRIPTION OF DRAWINGS

In order to more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinarily skilled in the art can also obtain other related drawings based on these drawings without inventive effort.

FIG. 1 is a first structural view of an inflation device provided in the embodiment of the present disclosure;

FIG. 2 is a second structural view of the inflation device provided in the embodiment of the present disclosure;

FIG. 3 is a third structural view of the inflation device provided in the embodiment of the present disclosure;

FIG. 4 is a fourth structural view of the inflation device provided in the embodiment of the present disclosure;

FIG. 5 is a first structural view of a main control board provided in the embodiment of the present disclosure;

FIG. 6 is a structural view of a switch module provided in the embodiment of the present disclosure;

FIG. 7 is a structural view of a switch module provided in another embodiment of the present disclosure;

FIG. 8 is a structural view of a switch module provided in another embodiment of the present disclosure;

FIG. 9 is a structural view of a first protection circuit provided in the embodiment of the present disclosure;

FIG. 10 is a first structural view of a second protection circuit provided in the embodiment of the present disclosure;

FIG. 11 is a second structural view of the second protection circuit provided in the embodiment of the present disclosure;

FIG. 12 is a third structural view of the second protection circuit provided in the embodiment of the present disclosure;

FIG. 13 is a fourth structural view of the second protection circuit provided in the embodiment of the present disclosure;

FIG. 14 is a first exploded view of the inflation pump provided in an embodiment of the present disclosure;

FIG. 15 is a first structural view of the inflation pump provided in an embodiment of the present disclosure;

FIG. 16 is a second exploded view of the inflation pump provided in the embodiment of the present disclosure;

FIG. 17 is a second structural view of the inflation pump provided in an embodiment of the present disclosure;

FIG. 18 is a third exploded view of the inflation pump provided in the embodiment of the present disclosure;

FIG. 19 is a third structural view of the inflation pump provided in an embodiment of the present disclosure;

FIG. 20 is a fourth exploded view of the inflation pump provided in the embodiment of the present disclosure; and

FIG. 21 is a fourth structural view of the inflation pump provided in an embodiment of the present disclosure.

Reference numerals: inflation device 1000; inflation pump 100; drive assembly 10; inflating assembly 20; transmission assembly 21; connecting rod 211; transmission wheel 212; housing 213; eccentric wheel 214; piston 215; housing cover 216; cylinder assembly 22; air nozzle 221; air cylinder 222; detection port 23; detection assembly 30; display assembly 40; main control board 200; microprocessor 210; switch module 220; first protection circuit 230; second protection circuit 240; power supply 300; casing 400; thermal insulating assembly 500; charging port 600; power transmission port 700; lighting lamp 800; heat dissipation assembly 900; heat dissipation housing 910; diode D3; MOS transistor Q5; MOS transistor Q2; MOS transistor Q7; resistor R15; resistor R25; resistor R30; resistor R52; resistor R53; resistor R56; resistor R57; resistor R42; resistor R18; resistor R39; resistor R12; resistor R14; resistor R41; resistor R35; resistor R13; resistor R38; resistor R1; resistor R6; resistor R22; resistor R40; capacitor C7; capacitor C16; capacitor C15; capacitor C14; capacitor C11; and comparator IC4.

### DETAILED DESCRIPTION OF EMBODIMENTS

In order to make the objectives, technical solutions, and advantages of the present disclosure clearer and more understandable, the present disclosure is described in further detail hereinafter in conjunction with the drawings and embodiments. It should be understood that the specific embodiments described herein are only for the purpose of explaining the present disclosure and are not intended to limit the present disclosure.

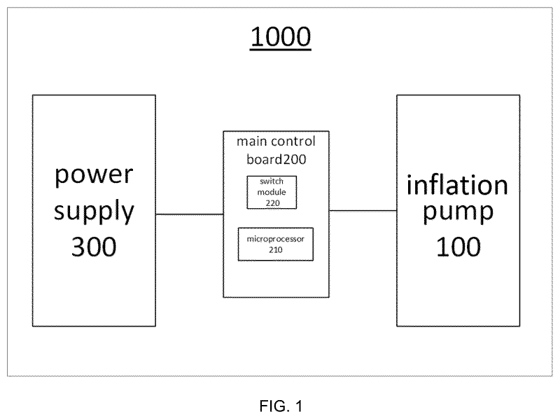

Referring to FIGS. 1 to 3, the inflation device 1000 can comprise a main control board 200, a power supply 300, a casing 400, and an inflation pump 100.

The main control board 200 is electrically connected to the detection assembly 30 of the inflation pump 100, for controlling the operating state of the inflation pump 100; the power supply 300 is electrically connected to the main control board 200 and the inflation pump 100, for supplying power to the main control board 200 and the inflation pump 100; and the inflation pump 100, the main control board 200, and the power supply 300 are arranged within the casing 400.

In the embodiment, the control side of the main control board 200 can be a key control panel; and the inflation pump 100 controls the operating state of the air pump by receiving operation command signals from corresponding function keys on the key control panel. The operating state can include, but is not limited to, turning on the power, turning off the power, increasing the inflation intensity, decreasing the inflation intensity, and adjusting the inflation mode.

In another embodiment, the control side of the main control board 200 can be a liquid crystal control panel, and the operation instructions on the liquid crystal control panel are similar to those on the key control panel, which can refer to the above, and will not be repeated herein.

Referring to FIG. 4, in the embodiment, the inflation device 1000 further comprises a thermal insulating assembly 500, and the thermal insulating assembly 500 is arranged between the inflating assembly 20 of the inflation pump 100 and the opening of the casing 400.

It is understood that, by providing the thermal insulating assembly 500 between the inflating assembly 20 and the opening of the casing 400, deformation of the casing 400 due to the influence of high-temperature inflating assembly 20 is avoided.

Exemplarily, the to-be-inflated device can be an item such as balls, tires, or the like.

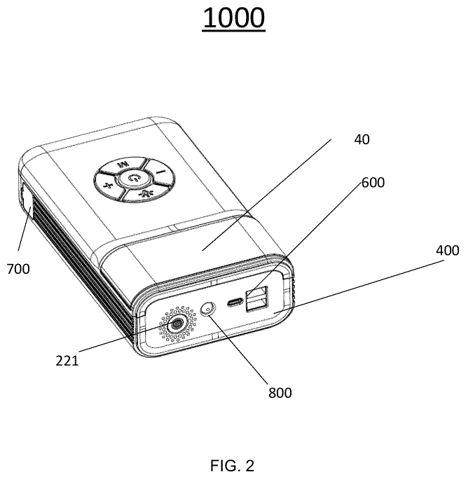

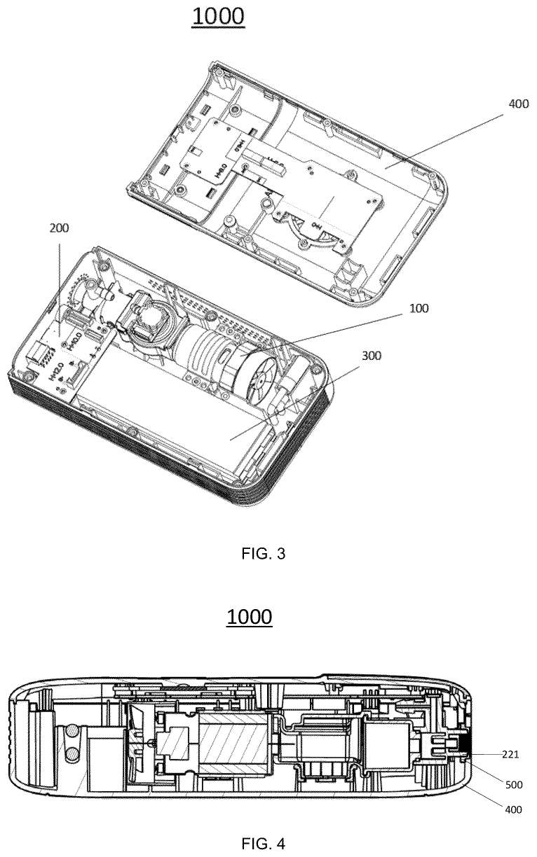

Referring to FIGS. 2 and 3, in the embodiment, the inflation device 1000 can further comprise a charging port 600 and a power transmission port 700, wherein the charging port 600 and the power transmission port 700 are provided on the casing 400 and are each connected to the power supply 300.

In the embodiment, the inflation device 1000 further comprises a pair of output terminals; and the power supply is electrically connected to the output terminals for outputting a third current for starting the engine of the vehicle.

In the embodiment of the present disclosure, the power supply 300 can be a battery, and the charging port 600 and the power transmission port 700 can include, but are not limited to, a USB Type-C port, a Micro USB port, a Lightning port, and the like.

It can be understood that the battery can be charged through the charging port 600, and the third current can be output through the power transmission port 700, which can facilitate the use of electricity by users in emergency situations. Exemplarily, the car is unable to be started when the power supply is low, at which time a specific cable clamp can be used to connect the power supply of the car to the inflation device 1000 through the power transmission port 700, so as to realize the starting of the car.

In the embodiment, the charging device can further comprise a lighting lamp 800, wherein the lighting lamp 800 can be provided on the casing 400 and electrically connected to the power supply 300 and the main control board 200.

It is understood that by activating the illumination button on the main control board 200, the inflation device 1000 can be used as a light source to illuminate the environment around the inflation device 1000.

In the embodiment, the main control board 200 comprises a microprocessor 210 and a switch module 220.

The microprocessor 210 is connected to the detection assembly 30 for generating output signals based on the air pressure information of the to-be-inflated device and a preset value; and the switch module 220 is connected to the microprocessor 210, for selectively connecting the power supply 300 to the inflation pump 100 based on the output signals.

It should be noted that the air pressure information is the value of the air pressure intensity.

In the embodiment, the microprocessor 210 is used to command the switch module 220 to be activated so that the power supply 300 is connected to the inflation pump 100, when the air pressure information of the to-be-inflated device is less than a preset value; or, to command the switch module 220 to be deactivated so that the power supply 300 is disconnected from the inflation pump 100 when the air pressure information of the to-be-inflated device is greater than or equal to a preset value.

Exemplarily, when the to-be-inflated device is an automobile tire, the preset value can be 36 PSI (Pounds per square inch). When the to-be-inflated device is a motorcycle tire, the preset value can be 35 PSI. When the to-be-inflated device is a bicycle tire, the preset value can be 45 PSI. When the to-be-inflated device is a ball (e.g., basketball, soccer ball, etc.), the preset value can be 8 PSI.

It should be noted that the preset value set above are for reference only and can be set according to the actual application, and the application is not limited in this way.

In the embodiment, the main control board 200 further comprises a switching module, wherein the switching module is connected to the microprocessor 210 for switching different preset values.

As can be understood, the switching module switches and changes the preset value, such that it is convenient to select a suitable preset value according to the type of the to-be-inflated device.

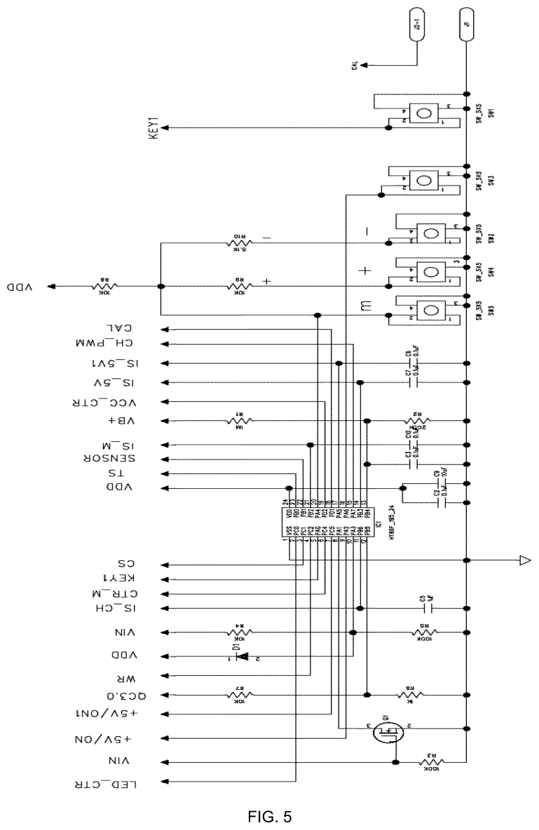

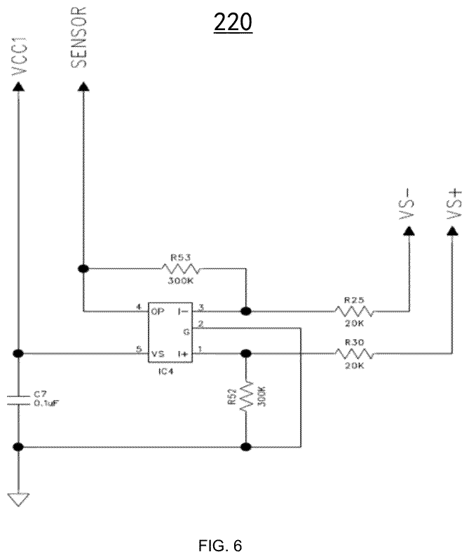

Exemplarily, referring to FIGS. 5 and 6 together, the IC1 is a microprocessor 210, wherein the sensor pin of the microprocessor 210 is connected to the switch module 220, and the microprocessor 210 controls the power supply 300 to be connected to or disconnected from the inflation pump 100 via the PC4 pin.

The switch module 220 comprises the resistor R25, the resistor R30, the resistor R52, the resistor R53, the resistor R22 and R40, the capacitor C7, and the comparator IC4.

The capacitor C7 is connected in parallel to the power supply terminal of the microprocessor 210 to supply power from the input voltage pin VS of the comparator IC4 to the ground (G pin). The resistor R25 is connected in series between the VS− pin of the inflation pump 100 and the I− pin of the IC4. The I− pin of the comparator IC4 connects the resistor R53 in series to the OP pin of the comparator IC4, which is connected to the sensor pin of the microprocessor 210. The resistor R30 is connected in series to the VS+ pin of the inflation pump 100, and the other end is connected to the I+ pin of the comparator IC4; and the resistor R52 is connected in series to the I+ pin of the comparator IC4, and the other end is connected to the VS pin of the comparator IC4.

It is to be understood that, the OP pin of the comparator, by connecting with the sensor pin of the microprocessor 210, obtains an electrical signal converted from the air pressure information of the to-be-inflated device, such that a potential difference is generated between the pin I− and the pin OP, and, consequently, the electric potential of the pin I− is unequal to that of the pin I+. With the feedback to the microprocessor 210, the microprocessor 210 commands the switch module 220 to inflate the to-be-inflated device. When the electrical signal received from the sensor pin approaches the preset value, the microprocessor 210 commands the switch module 220 to stop inflating the to-be-inflated device.

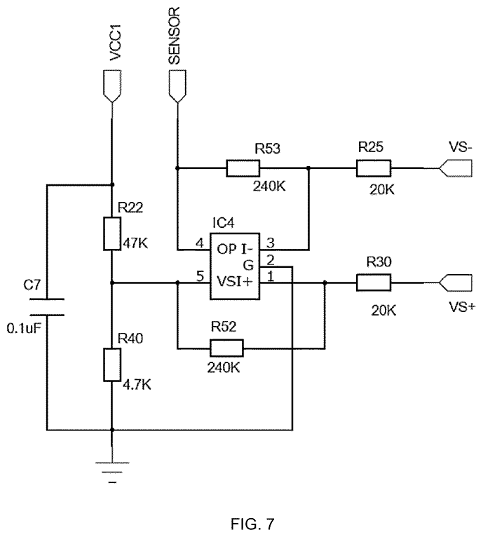

In another embodiment, referring to FIG. 7, the switch module 220 can further comprise a resistor R22 and a resistor R40.

The resistor R22 is connected to the capacitor C7 and the VS pin of the comparator IC4, respectively; one end of the capacitor C7 is connected to the power supply terminal of microprocessor 210, and the other end is grounded; one end of the resistor R40 is connected to resistor R22 and the VS pin, and the other end of the resistor R40 is grounded; the VS pin of the comparator IC4 is connected in series with the resistor R52 to the I+ pin of comparator IC4, which are connected to resistor R30; and the resistor R30 is connected to the inflation pump 100 in series. The resistor R25 is connected in series between the VS− pin of the inflation pump 100 and the I− pin of the IC4; and the I− pin of the comparator IC4 is connected in series with the resistor R53 to the OP pin of the comparator IC4, which is connected to the sensor pin of the microprocessor 210.

It is understood that the signal transmitted by the microprocessor 210 is compensated by providing the resistor R22 and the resistor R40.

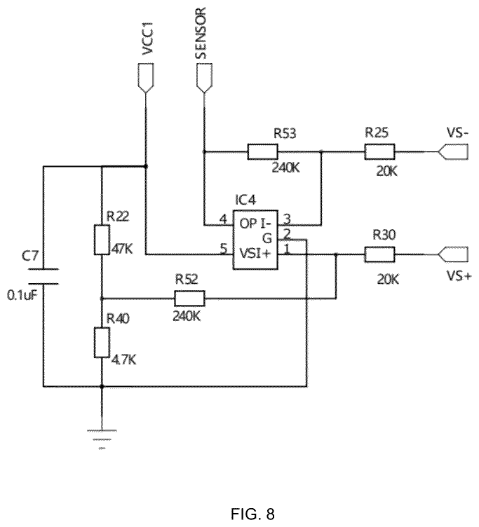

In yet another embodiment, for ease of understanding, the various components and connection methods in the switch module 220 can also be shown in FIG. 8.

Specifically, one end of resistor R52 is connected to the resistor R22 and the resistor R40, respectively, and the other end is connected to the I+ pin of the comparator IC4 and the resistor R30; the VS pin of the comparator IC4 is connected to the capacitor C7, the resistor R22, and the power supply terminal of microprocessor 210, respectively, and the other ends of the capacitor C7 and the resistor R40 are grounded; the resistor R25 is connected in series between the VS− pin of the inflation pump 100 and the I− pin of IC4; and the I− pin of comparator IC4 is connected in series with resistor R53 to the OP pin of the comparator IC4, which is connected to the sensor pin of the microprocessor 210. The resistor R30 is connected in series with the VS+ pin of the inflation pump 100 and the other end is connected to the I+ pin of the comparator IC4.

It is understood that the voltage of the power supply terminal (VCC1) of the microprocessor 210 is divided by R22 and R40, and its voltage value is applied the op-amp (operational amplifier) IC4 via R52, thereby compensating the signal transmitted by the microprocessor 210.

In the embodiment, the inflation device can further comprise a first protection circuit. The first protection circuit is coupled to the power supply for the protection of the power supply.

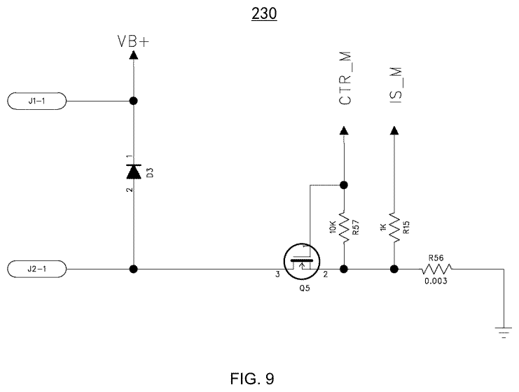

Referring to FIG. 9, the first protection circuit comprises the diode D3, the MOS transistor Q5, the resistor R56, the resistor R57, and the resistor R15. The positive terminal of the diode D3 is connected to the drain of the MOS transistor Q5 and the negative terminal J2-1 of the drive assembly, respectively, and the negative terminal of the diode D3 is connected to the PB4 pin of the microprocessor 210 and to the positive terminal J1-1 of the drive assembly of the inflation pump 100, respectively. The source of the MOS transistor Q5 is connected to one ends of the resistor R57, the resistor R15, and the resistor R56, respectively; and the gate of the MOS transistor Q5 is connected to the other end of the resistor R57 and the PC4 pin of the microprocessor 210, respectively. The other end of the resistor R15 is connected to the PB2 pin of the microprocessor 210 and the other end of resistor R56 is grounded. The PB4 pin is used to detect the current battery voltage; and the PB2 pin is used to detect the operating current of the inflation pump 100 and to stop the inflation pump 100 when the operating current exceeds the threshold.

The MOS transistor Q5 can be an N-channel depletion-type field effect transistor. The D3 is the freewheel diode, which prevents damage to circuit components caused by transient current. The resistor R57 is used for the PB2 pin of the microprocessor 210 to be pulled down to ground, which enhances its resistance to interference and prevents abnormal operation of MOS transistor Q5 caused by interference signals. The resistor R15 is used to reduce the limiting current, as well as to cooperate with the microprocessor 210 to detect the current on the resistor R56; and when exceeding the preset value of the protection current of the air pump, the inflation pump 100 will shut down its operating state and enter soft protection.

In the embodiment, the inflation device can further comprise a second protection circuit. The second protection circuit is coupled to the power supply for the protection of the power supply.

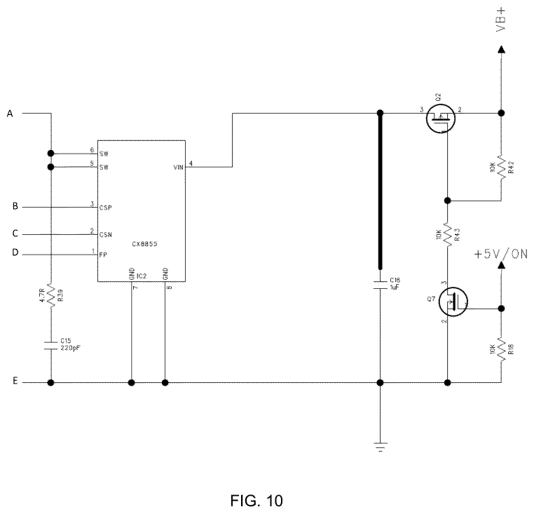

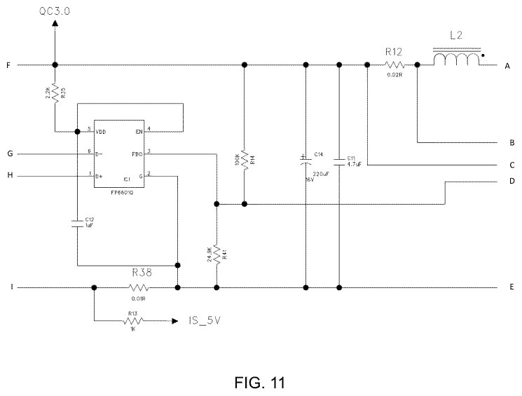

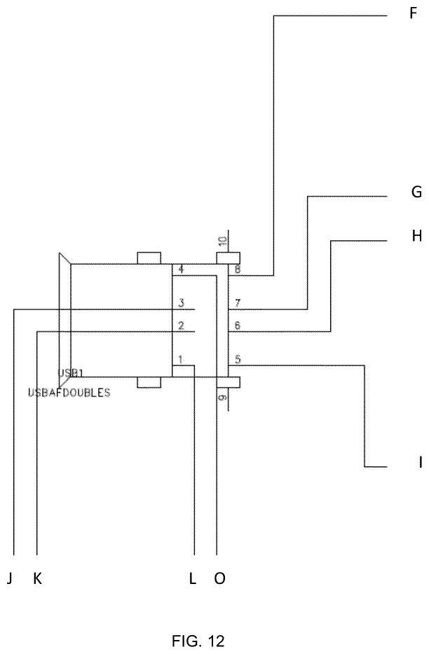

Referring to FIGS. 10 to 13, these drawings constitute a complete second protection circuit diagram, wherein the connection endpoints of each drawing are shown as A-O. The second protection circuit can include the resistors R42, R18, R39, R12, R14, R41, R35, R13, R38, R1 and R6; the MOS transistors Q2 and Q7; the capacitors C16, C15, C11 and C14; the microprocessor IC2; and the inductor L2.

The PB4 pin of the microprocessor IC1 is connected to the resistor R42 and the source of the MOS transistor Q2, respectively, wherein the PB4 pin is used to detect the current voltage of the battery. The resistor R43 is connected to the gate of the MOS transistor Q2 and the other end of the resistor R42, respectively; the drain of the MOS transistor Q2 is connected to the VIN pin of the microprocessor IC2 and the capacitor C16, respectively, and the other end of the capacitor C16 is grounded; the drain of the MOS transistor Q7 is connected to the resistor R43 and the gate of the MOS transistor Q7 is connected to the PA2 pin of the microprocessor IC1 and the resistor R18, respectively, the other end of the resistor R18 is grounded and the source of the MOS transistor Q7 is grounded; and the PA2 pin is used to control Q7 to turn on Q2, and allow the battery voltage VB+ to power IC2 for voltage reduction, thereby resulting in an output on the QC3.0 port.

The inductor L2 is connected to the SW pin and CSP pin of the microprocessor IC2, respectively, and the resistor R12 is connected to the inductor L2 and the CSP pin of the microprocessor IC2. One end of the resistor R39 is connected to the SW pin of the microprocessor IC2 and the other end is connected to the capacitor C15, and the other end of the capacitor C15 is grounded. The capacitor C11 is connected in parallel to the CSN pin of the microprocessor IC2 and ground wire, respectively. The capacitor C14 is provided in parallel with the capacitor C11. The resistor R14 is provided in parallel with the capacitors C14 and C11.

One end of the resistor R41 is connected to the FBO of the microprocessor IC3 and the other end is grounded; and the capacitor C12 is provided in parallel with the EN pin and VDD pin of the microprocessor IC3. One end of the resistor R13 is connected to the PB3 pin of the microprocessor IC1 and the other end is connected to the resistor R38. The PB3 pin is used to detect the output current of the QC3.0 port. The D− and D+ pins of the microprocessor are connected to the resistors R1 and R6, respectively, via USB cable; and the other ends of the resistors R1 and R6 are connected to the resistor R34 and the source of MOS transistor Q6. The other end of the resistor R34 is connected to the PCO pin and the gate of the MOS transistor Q6, respectively; and the drain of the MOS transistor Q6 is connected to the negative terminal of the diode D4. The positive terminal of the diode D4 is connected to the resistor R8 and the other end of the resistor R8 is connected to the output port of the inflation pump.

It is understood that the resistors R38 and R13 in the second protection circuit cooperate with each other to protect the inflation pump from overcurrent, thereby realizing hardware protection for the VIN pin of the microprocessor.

It should be noted that when the output ports of the inflation pump are multiple, overcurrent protection can be applied to each output port by setting secondary protection circuits in a corresponding number. The previous explanation only provides an illustrative example of a single secondary protection circuit, and the present disclosure is not limited thereto.

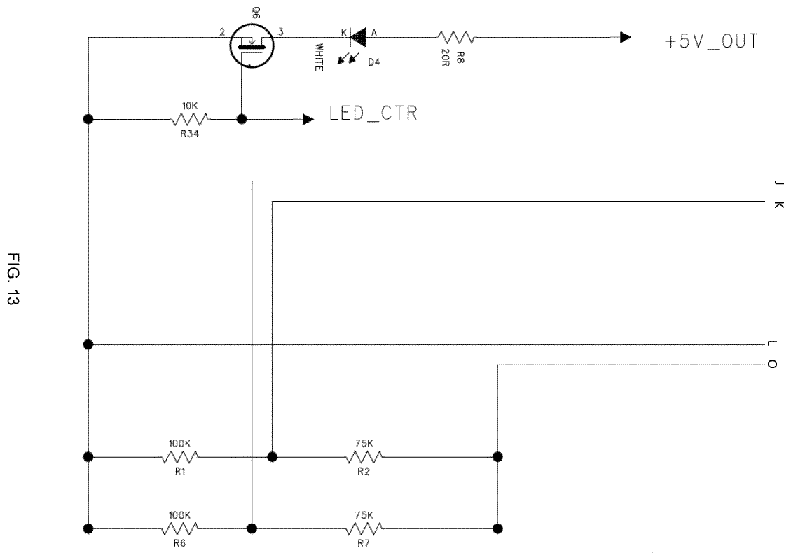

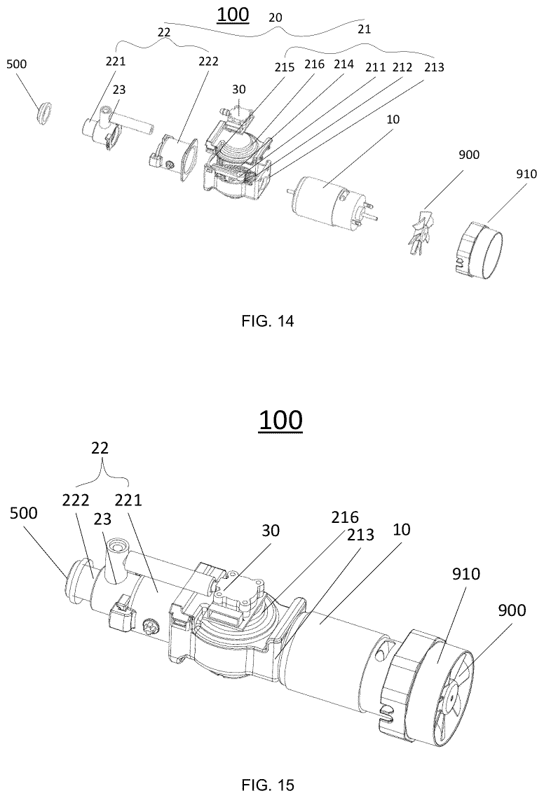

Referring to FIGS. 14 and 15, in the embodiment, the inflation pump 100 can comprise a drive assembly 10, an inflating assembly 20, and a detection assembly 30.

One end of the drive assembly 10 is connected to the inflating assembly 20 to provide power to the inflating assembly 20; an end of the inflating assembly 20 away from the drive assembly 10 is used to connect to a to-be-inflated device; a side of the inflating assembly 20 near the to-be-inflated device is provided with a detection port 23; and the detection assembly 30 is connected to the detection port 23 for detecting the air pressure information of the to-be-inflated device.

It is understood that, when the to-be-inflated device is connected to the inflating assembly 20, the air pressure information is the same for both. Therefore, by connecting the detection assembly 30 to the detection port 23 on the inflation device, the detection assembly 30 can obtain the air pressure information of the to-be-inflated device. Further, when the drive assembly 10 drives the inflating assembly 20 to inflate the to-be-inflated device, it is possible to evaluate whether the inflation amount for the to-be-inflated device is appropriate based on the air pressure information of the to-be-inflated device.

In the embodiment, the inflation pump 100 can further comprise a display assembly 40, wherein the display assembly 40 is connected to the microprocessor 210, which is configured to display the air pressure information by signaling the air pressure information of the to-be-inflated device detected by the detection assembly 30 through the microprocessor 210.

The display assembly 40 comprises, but is not limited to, a digital display screen, an LED indicator, and the like.

It is to be understood that displaying the air pressure information by the display assembly 40 enables the user to intuitively obtain the current air pressure information of the to-be-inflated device.

In the embodiment, the inflating assembly 20 can comprise a transmission assembly 21 and a cylinder assembly 22.

One end of the transmission assembly 21 is connected to the drive assembly 10 and the other end away from the drive assembly 10 is connected to the cylinder assembly 22 for transmitting power to the cylinder assembly 22, and the detection port 23 is provided on the side of the cylinder assembly 22 near the to-be-inflated device.

In the embodiment, the transmission assembly 21 can comprise a connecting rod 211, a transmission wheel 212, a housing 213, an eccentric wheel 214 arranged on the housing 213, and a piston 215 arranged on the connecting rod 211.

One end of the piston 215 away from the connecting rod 211 is connected to the cylinder assembly 22 and one end of the connecting rod 211 away from the piston 215 is connected to the eccentric wheel 214; the transmission wheel 212 is connected to the eccentric wheel 214 and the drive assembly 10, respectively, for transmitting power to the eccentric wheel 214; one end of the housing 213 is connected to the drive assembly 10 and the other end away from the drive assembly 10 is connected to the cylinder assembly 22; and the eccentric wheel 214 and the transmission wheel 212 are spiral bevel gears.

Specifically, the housing 213 is provided with an accommodating space and two sides of the housing 213 are each provided with an opening. The eccentric wheel 214 is provided at the bottom of the accommodating space and the transmission wheel 212 is located within the accommodating space. The drive shaft of the drive assembly 10 is connected to the transmission wheel 212 from an opening on one side of the housing 213. The piston 215 is connected to the cylinder assembly 22 from an opening on the other side of the housing 213.

It is to be understood that, by connecting the two ends of the housing 213 to the drive assembly 10 and the cylinder assembly 22, respectively, the eccentric wheel 214 provided on the housing 213 is limited, thereby avoiding the damage to the inflation pump 100 caused by the movement of the eccentric wheel 214. Moreover, the eccentric wheel 214 and the transmission wheel 212 are provided as a structure of spiral bevel gears, which makes the connecting portion of the eccentric wheel 214 and the transmission wheel 212 compact. Compared with the traditional transmission method using straight gear, the transmission of the transmission wheel 212 and the eccentric wheel 214 is more stable and the transmission efficiency is higher.

In the embodiment, the transmission assembly 21 also comprises a housing cover 216, and the housing cover 216 is connected to the housing 213.

The housing 213 and the housing cover 216 can be constructed in an upper and lower layer, and the housing 213 is fixedly connected to a lower end of the housing cover 216 through four threaded ports at an upper end of the housing 213. The detection assembly 30 can be provided on an upper surface of the housing cover 216.

It is to be understood that, a housing cover 216 is connected to the housing 213 so that the eccentric wheel 214 arranged on the housing 213 is covered by the housing cover 216. Therefore, the probability of foreign matter entering the eccentric wheel 214 is reduced, and the protection for the eccentric wheel 214 is improved.

In the embodiment, the cylinder assembly 22 can comprise an air nozzle 221 and an air cylinder 222.

The air nozzle 221 is provided with the detection port 23, and one end of the air nozzle 221 is used to connect to the to-be-inflated device. One end of the air cylinder 222 is connected to one end of the air nozzle 221 away from the to-be-inflated device, and one end of the air cylinder 222 away from the air nozzle 221 is connected to the transmission assembly 21.

The air cylinder 222 can be a cylindrical body such as a cylinder, a square cylinder, etc., and the shape of the air cylinder 222 can be specifically selected according to the actual application. The air cylinder 222 can be snapped to the slots on both sides of the air nozzle 221 through the fasteners on both sides, thereby realizing the fixed connection between the air cylinder 222 and the air nozzle 221.

In the embodiment, the air nozzle 221 and the air cylinder 222 can be detachably connected.

It is understood that, by detachably connecting the air nozzle 221 to the air cylinder 222, it allows the user to replace the appropriate air nozzle 221 according to the specifications of the inflation port of the object to be inflated, so as to improve the adaptability of the inflation pump 100 to each to-be-inflated device.

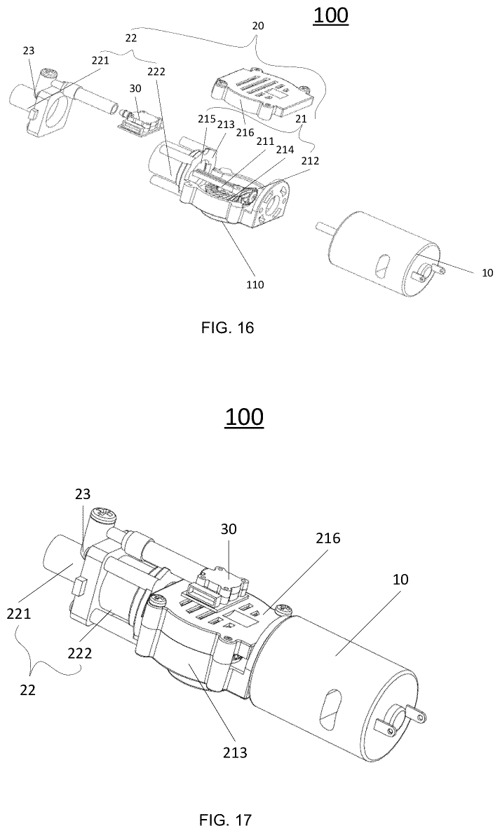

Referring to FIGS. 16 and 17, in the embodiment, the air nozzle 221 is connected to the transmission assembly 21; an accommodating space is formed at the connection position between the air nozzle 221 and the transmission assembly 21; and the air cylinder 222 is located in the accommodating space.

Specifically, the air nozzle 221 can be fixedly connected by threads to threaded slots distributed on one side of the transmission assembly 21.

It is understood that, by providing the air cylinder 222 in the accommodating space formed at the connection position between the air nozzle 221 and the transmission assembly 21, the space occupied by the components of the inflation pump 100 is reduced and the volume of the inflation pump 100 is reduced.

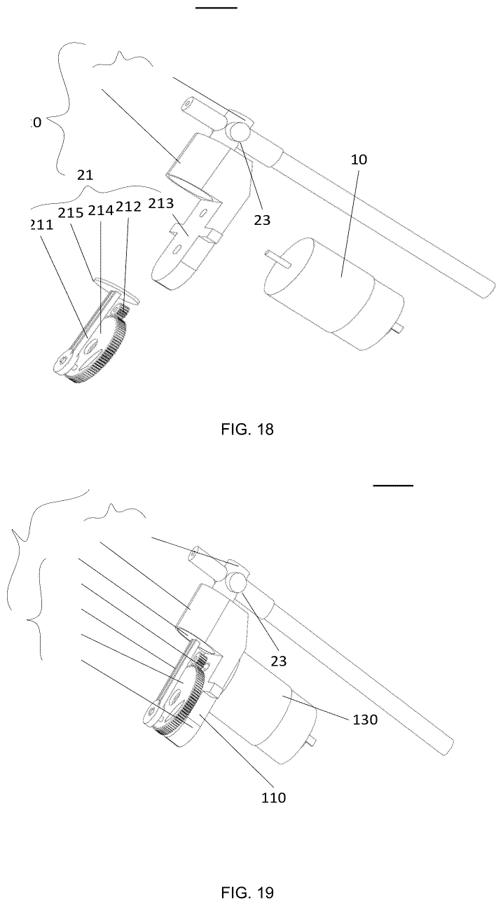

Referring to FIGS. 18 and 19, in another embodiment, the inflating assembly 20 comprises a transmission assembly 21 and a cylinder assembly 22.

One end of the cylinder assembly 22 is connected to the drive assembly 10 with a detection port 23 provided on the side near the to-be-inflated device; and the transmission assembly 21 is provided on the cylinder assembly 22 for transmitting the power to the cylinder assembly 22.

It is understood that, the cylinder assembly 22 is fixedly connected to the transmission assembly 21 by providing the transmission assembly 21 on the cylinder assembly 22, so as to avoid that the transmission assembly 21 is separated from the cylinder assembly 22, which prevents the inflation pump 100 from functioning properly.

In the embodiment, the transmission assembly 21 comprise a connecting rod 211, a transmission wheel 212, an eccentric wheel 214 arranged on the cylinder assembly 22, and a piston 215 arranged on the connecting rod 211.

One end of the connecting rod 211 is connected to the cylinder assembly 22, and the other end away from the cylinder assembly 22 is connected to the eccentric wheel 214; and the transmission wheel 212 is connected to the eccentric wheel 214 and the drive assembly 10, respectively, for transmitting power.

In the embodiment, the cylinder assembly 22 comprises an air nozzle 221, an air cylinder 222, and a housing 213.

The air nozzle 221 is provided with the detection port 23; one end of the air nozzle 221 is used to connect to the to-be-inflated device, and the other end away from the to-be-inflated device is connected to the air cylinder 222; the transmission assembly 21 is provided on the housing 213; the air cylinder 222 is connected to the housing 213; and the housing 213 is connected to the drive assembly 10.

In the embodiment, an opening is provided at the bottom of the housing 213, and the drive shaft of the drive assembly 10 is connected to the transmission assembly 21 in a manner that penetrates the opening.

It is understood that the opening is provided at the bottom of the housing 213, and the drive shaft of the drive assembly 10 is connected to the transmission assembly 21 in a manner that penetrates the opening at the bottom of the housing 213, thereby reducing the length in the direction of the drive shaft of the inflation pump.

In the embodiment, the air nozzle 221, the air cylinder 222, and the housing 213 can be of an integrally molded structure.

It is understood that, by integrally molding the air nozzle 221, the air cylinder 222, and the housing 213, the sealing of the connection between the inflation mechanism and the to-be-inflated device is improved, as well as the overall solidity.

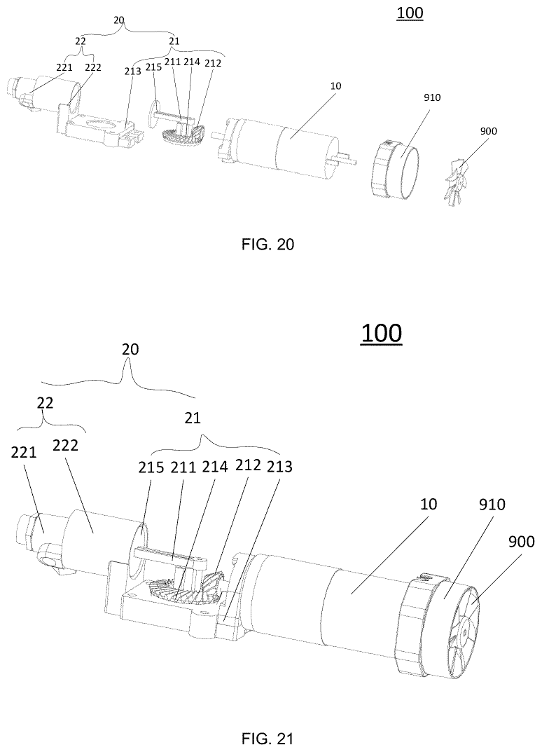

Referring to FIGS. 20 and 21, in the embodiment, the inflation pump 100 further can comprise a heat dissipation assembly 900, arranged on a side of the drive assembly 10 away from the transmission assembly 21, for heat dissipation of the drive assembly 10.

Exemplarily, the heat dissipation assembly 900 can include, but is not limited to, a fan, a heat sink, and the like.

When the heat dissipation assembly 900 is a fan, it can be provided on the side of the drive assembly 10 away from the transmission assembly 21, so as to exhaust the heat emitted by the drive assembly 10. In addition, when the heat dissipation assembly 900 is a heat sink, the heat sink can be arranged to be affixed to a position where the drive assembly 10 generates a lot of heat, so as to improve the ability of the drive assembly 10 to dissipate heat.

It is understood that, by providing the heat dissipation assembly 900 on the side of the drive assembly 10 away from the transmission assembly 21, heat is dissipated from the drive assembly 10, so that the heat generated by the drive assembly 10 during operation can be effectively dispersed, thereby improving the service life of the inflation pump 100.

In the embodiment, the inflation pump 100 can further comprise a heat dissipation housing 910, wherein the heat dissipation housing 910 is disposed over a surface of the heat dissipation assembly 900.

It is understood that by disposing the heat dissipation housing 910 over the surface of the heat dissipation assembly 900, the heat dissipation assembly 900 is prevented from falling off and damaging the inflation pump 100.

In embodiments of the present disclosure, the detection assembly 30 can include an air pressure sensor assembly, wherein the air pressure sensor assembly is communicated with the detection port 23.

In the embodiment, the detection assembly 30 can further comprise an air hose, wherein one end of the air hose is connected to the air pressure sensor assembly, and the other end is connected to the detection port 23.

It can be understood that, by connecting the two ends of the air hose to the air pressure sensor assembly and the detection port 23 respectively, the mounting position of the air pressure sensor assembly is more flexible and versatile, thereby making it easy to mount.

In the embodiments provided in the present disclosure, it should be understood that the devices disclosed can be implemented in other ways. The above-described embodiments of the device are merely schematic, for example, the division of the mechanism described, which is only a logical functional division, can be divided in another way when actually implemented; and for another example, multiple mechanisms or components can be combined or can be integrated into another system, or some features can be ignored, or not implemented.

In the context, relationship terms such as first and second are used only to distinguish one entity or operation from another, without necessarily requiring or implying any such actual relationship or order between those entities or operations.

Multiple means two or more herein.

The above is only an embodiment of the present disclosure, which is not intended to limit the scope of protection of the present disclosure, and the present disclosure can have various changes and variations for those skilled in the art. Any modification, equivalent substitution, improvement, etc. made within the spirit and principles of the present disclosure shall be included in the scope of protection of the present disclosure.

1. An inflation pump, comprising:
a drive assembly, an inflating assembly, and a detection assembly, wherein
one end of the drive assembly is connected to the inflating assembly to provide power for the inflating assembly;
one end of the inflating assembly away from the drive assembly is configured to be connected to a to-be-inflated device, and one end of the inflating assembly close to the to-be-inflated device is provided with a detection port; and
the detection assembly is connected to the detection port and configured to detect air pressure information of the to-be-inflated device.

2. The inflation pump according to claim 1, wherein the inflating assembly comprises:
a transmission assembly and a cylinder assembly, wherein
the transmission assembly has one end connected to the drive assembly and the other end away from the drive assembly connected to the cylinder assembly and configured to transmit power to the cylinder assembly; and
the detection port is provided at a side of the cylinder assembly close to the to-be-inflated device.

3. The inflation pump according to claim 2, wherein the transmission assembly comprises:
a connecting rod, a transmission wheel, a housing, an eccentric wheel arranged on the housing, and a piston arranged on the connecting rod, wherein
one end of the piston away from the connecting rod is connected to the cylinder assembly and one end of the connecting rod away from the piston is connected to the eccentric wheel;
the transmission wheel is connected to the eccentric wheel and the drive assembly, respectively, and configured to transmit power to the eccentric wheel; and
the housing has one end connected to the drive assembly and the other end, away from the drive assembly, connected to the cylinder assembly.

4. The inflation pump according to claim 3, wherein the transmission assembly further comprises a housing cover, and the housing cover is connected to the housing.

5. The inflation pump according to claim 2, wherein the cylinder assembly comprises:
an air nozzle and an air cylinder, wherein
the air nozzle is provided with the detection port, and one end of the air nozzle is configured to be connected to the to-be-inflated device; and
one end of the air cylinder is connected to one end of the air nozzle away from the to-be-inflated device, and one end of the air cylinder away from the air nozzle is connected to the transmission assembly.

6. The inflation pump according to claim 5, wherein the air nozzle is connected to the transmission assembly; an accommodating space is formed at a connection position between the air nozzle and the transmission assembly; and the air cylinder is located in the accommodating space.

7. The inflation pump according to claim 1, wherein the inflating assembly comprises:
a transmission assembly and a cylinder assembly, wherein
one end of the cylinder assembly is connected to the drive assembly and the detection port is provided on one side of the cylinder assembly close to the to-be-inflated device; and
the transmission assembly is provided on the cylinder assembly and configured to transmit power to the cylinder assembly.

8. The inflation pump according to claim 7, wherein the transmission assembly comprises:
a connecting rod, a transmission wheel, an eccentric wheel arranged on the cylinder assembly, and a piston arranged on the connecting rod, wherein
the connecting rod has one end connected to the cylinder assembly and the other end away from the cylinder assembly connected to the eccentric wheel; and
the transmission wheel is respectively connected to the eccentric wheel and the drive assembly to transmit the power.

9. The inflation pump according to claim 7, wherein the cylinder assembly comprises:
an air nozzle, an air cylinder, and a housing, wherein
the air nozzle is provided with the detection port; and the air nozzle has one end configured to be connected to the to-be-inflated device and the other end away from the to-be-inflated device connected to the air cylinder;
the transmission assembly is provided on the housing;
the air cylinder is connected to the housing; and
the housing is connected to the drive assembly.

10. The inflation pump according to claim 9, wherein
a bottom of the housing is provided with an opening; and
a drive shaft of the drive assembly penetrates through the opening and is connected to the transmission assembly.

11. The inflation pump according to claim 9, wherein the air nozzle, the air cylinder, and the housing are integrally molded.

12. The inflation pump according to claim 2, wherein the inflation pump further comprises a heat dissipation assembly, wherein the heat dissipation assembly is arranged on a side of the drive assembly away from the transmission assembly and configured to perform heat dissipation for the drive assembly.

13. The inflation pump according to claim 1, wherein the detection assembly comprises:
an air pressure sensor assembly, communicated with the detection port.

14. An inflation device, comprising:
the inflation pump according to claim 1;
a main control board, electrically connected to the detection assembly of the inflation pump, and configured to control an operating state of the inflation pump;
a power supply, electrically connected to the main control board and the inflation pump, and configured to supply power to the main control board and the inflation pump; and
a casing, wherein the inflation pump, the main control board, and the power supply are located in the casing.

15. The inflation device according to claim 14, wherein the inflation device further comprises a thermal insulating assembly, and the thermal insulating assembly is provided between the inflating assembly of the inflation pump and the casing.

16. The inflation device according to claim 14, wherein the main control board comprises:
a microprocessor and a switch module, wherein
the microprocessor is connected to the detection assembly and configured to generate output signals based on the air pressure information of the to-be-inflated device and a preset value; and
the switch module is connected to the microprocessor, and configured to selectively connect the power supply to the inflation pump based on the output signals.

17. The inflation device according to claim 16, wherein the microprocessor is configured to command the switch module to be activated so that the power supply is connected to the inflation pump, when the air pressure information of the to-be-inflated device is less than the preset value; or, to command the switch module to be deactivated so that the power supply is disconnected from the inflation pump, when the air pressure information of the to-be-inflated device is greater than or equal to the preset value.

18. An inflation device, comprising:
the inflation pump according to claim 1, a power supply, at least one current output port, a first protection circuit, and a second protection circuit, wherein
the power supply is electrically connected to the at least one current output port and configured to output a first current to external devices;
the power supply is electrically connected to the inflation pump and configured to output a second current to the inflation pump;
the first protection circuit is coupled to the power supply and configured to protect the power supply; and
the second protection circuit is coupled to the power supply and configured to perform overcurrent protection for the inflation pump.

19. The inflation device according to claim 18, further comprising:
a pair of output terminals; and
the power supply is electrically connected to the output terminals and configured to output a third current for starting an engine of a vehicle.
